(19) United States
(12) Patent Application Publication
(10) Pub. No.: US 2023/0306507 A1
(43) Pub. Date: Sep. 28, 2023

(54) Computer-Implemented Method for Visualising a Performance of at least One Trader

(71) Applicant: Brady Energy UK Limited, Edinburgh (GB)

(72) Inventors: Chris REGAN, LONDON (GB); Dmitrii ISHUTIN, LONDON (GB)

(21) Appl. No.: 17/705,199

(22) Filed: Mar. 25, 2022

(51) Int. Cl. G06Q 40/04

(52) U.S. Cl. CPC G06Q 40/04

(57) ABSTRACT

A computer-implemented method is disclosed for visualising a performance of an automated trading application in a short-term energy trading market. The method comprises: determining a net open position; determining a direction of trade indicating whether buying or selling is required to balance the net open position; obtaining a forecast price direction and forecast market liquidity based on current market analysis; determining a timing recommendation comprising a recommendation to hold or close the net open position; determining a confidence level for the timing recommendation; generating a graph wherein a first axis represents the confidence level for the timing recommendation and a second axis represents whether the automated trading application is in a profitable position or in a non-profitable position; and determining each automated trading application's location on the graph and plotting each automated trading application's location using an icon representing each automated trading application.

### FIELD OF DISCLOSURE

The disclosure relates to a computer-implemented method for visualising a performance of at least one automated trading application.

### BACKGROUND

As a consequence of de-carbonisation and de-centralisation, energy generation from traditional large-scale power plants is gradually being replaced by that from renewable and other energy sources such as solar and wind power.

Similarly, traditional energy trading, based on a long-term outlook, is being transformed and there is a move to short-term (intra-day) energy trading. However, to date, entering the short-term energy trading market has required significant investment in systems, knowledge and infrastructure to manage real-time physical delivery. Legacy systems designed for coal and gas power generation are simply unsuitable to provide the required response times and therefore a new system for effectively managing short-term energy trading, and the associated energy output, is required.

The present disclosure therefore seeks to overcome shortcomings of the prior art systems and/or provide a useful alternative.

### SUMMARY

One or more aspects of the present disclosure relate to a computer-implemented method for visualising a performance of at least one automated trading application in a short-term energy trading market. The method results in a graph showing whether the automated trading application is in a profitable position or in a non-profitable position alongside a confidence level associated with waiting to trade. As such, a user can quickly assess the performance of each automated trading application and can decide to intervene if necessary.

In accordance with a first aspect of the disclosure there is provided a computer-implemented method for visualising a performance of at least one automated trading application in a short-term energy trading market, the method comprising:
determining a net open position based on a difference between forecasted energy generation and forecasted energy sales for a portfolio of assets for one or more trading periods;
determining a direction of trade indicating whether buying or selling is required to balance the net open position;
obtaining a forecast price direction for the buying or selling based on current market analysis;
obtaining a forecast of market liquidity for the one or more trading periods based on current market analysis;
determining a timing recommendation for the buying or selling, based on the direction of trade, the forecast price direction and remaining market liquidity, the timing recommendation comprising a recommendation to hold or close the net open position;
determining a confidence level for the timing recommendation based on a confidence level of the forecast price direction and the forecast of market liquidity;
generating a graph wherein a first axis represents the confidence level for the timing recommendation and a second axis represents whether the automated trading application is in a profitable position or in a non-profitable position;
determining each automated trading application's location on the graph and plotting each automated trading application's location using an icon representing each automated trading application.

Embodiments of the first aspect of the disclosure therefore relate to a method for visualising a performance of an automated trading application, quickly and easily. Not only is it possible to determine whether the automated trading application is in a profitable position or in a non-profitable position at a glance, but it is also possible to assess a degree of confidence in when automated trading application is likely to trade.

The net open position (NOP) represents what a trader needs to do to close out the position and become balanced. For example, if a trader has 100 MW of generation and 80 MW of sales then they will need to sell another 20 MW to become balanced. Conversely, if a trader has 90 MW of generation and 100 MW of sales then they will need to buy another 10 MW to become balanced.

The forecast price direction may be obtained from an external source and/or may be calculated by subtracting a current market price from a future forecast market price. In some cases, the forecast price direction may be determined by a regression analysis of a similar period from history and may comprise using correlations to live independent variables such as weather.

The at least one automated trading application may comprise an algorithm configured to execute a trade to close a net open position for a given trading period or to wait to close the net open position depending on the forecast price direction and the remaining market liquidity. The remaining market liquidity may be predicted by subtracting the actual trades for the trading period (and trading instrument concerned) from the forecast of market liquidity for the trading period. For example, the timing recommendation may be to wait to trade at the 75 percentile of the forecast of market liquidity (i.e. to wait until 25% of the forecast of market liquidity remains).

The at least one automated trading application may comprise a trained machine-learning algorithm. The trained machine learning algorithm may comprise a neural network trained to execute a trade to close a net open position.

The portfolio may include one or more assets, with each asset being capable of generating and supplying energy for sale or purchase on an energy trading exchange.

The one or more trading periods may each have a duration of one market settlement period. For example, in the UK, the local market settlement period is 30 minutes. However, in other countries or markets the duration of one market settlement period may be different.

The method may further comprise:
determining for each automated trading application:
   an upper boundary for closing the net open position to take profit; and
   a lower boundary for closing the net open position to stop losses; and
indicating the upper boundary and the lower boundary on the graph.

The method may further comprise normalising each automated trading application's position along the second axis such that each automated trading application can be viewed relative to a common upper boundary and a common lower boundary.

The first axis may comprise a first zone indicating a low confidence level for holding the net open position; a second zone indicating a medium confidence level for holding the net open position; a third zone indicating a high confidence level for holding the net open position. For example, the low confidence level may be less than 30%, the medium confidence level may be from 30% to 70%; and the high confidence level may be greater than 70%.

The first axis may comprise a fourth zone indicating a low confidence level for closing the net open position. For example, the low confidence level may be less than %.

The fourth zone may be indicated on a first (e.g. negative) side of the second axis and the first zone, the second zone and the third zone may be indicated on a second (e.g. positive) side of the second axis.

A first (e.g. positive) side of the first axis may indicate a profitable position and a second (e.g. negative) side of the first axis may indicate a non-profitable position.

The first axis may be a vertical y-axis and the second axis may be a horizontal x-axis.

The confidence level for the timing recommendation may be determined by the confidence level of the forecast price direction and a confidence level that sufficient market liquidity remains to allow the net open position to be closed.

Whether the automated trading application is in a profitable position or in a non-profitable position may be determined by subtracting a first market price from when the automated trading application started trading from a current market price.

The method may further comprise an option to display one or more of: a previous location for at least one automated trading application; a path of movement of the location for at least one automated trading application; and a direction of movement of the location of the at least one automated trading application along the path. As such the relative change in position of the automated trading application can shown to track movement within the graph.

The step of determining the timing recommendation may comprise:
determining to close the net open position when either:
   the direction of trade is to buy and the forecast price direction is rising; or
   the direction of trade is to sell and the forecast price direction is falling; and
determining to hold the net open position when either:
   the direction of trade is to buy and the forecast price direction is falling; or
   the direction of trade is to sell and the forecast price direction is rising.

The step of determining the timing recommendation may comprise, in response to a determination to hold the net open position, considering the forecast of market liquidity to determine how long the position should be held open for; and determining to close the net open position when the remaining market liquidity reaches a predetermined threshold.

The icon may be configured to provide a visual representation of a trading pattern being applied by the automated trading application.

The icon may be a bull in the case of a rising market and a bear in the case of a falling market.

The icon may include an identifier (ID) for the automated trading application concerned.

The icon may be configured to indicate a status of the automated trading application.

The status of the automated trading application may be one of: active; paused; or in-active.

The method may further comprise showing a visible change to an icon on the graph when an action occurs.

The visible change may comprise, for example, one or more of:
an explosion when a trade is executed; and
a fading out when the net open position is balanced or a trading period is closed.

The method may further comprise an option for a user to configure one or more of: a date or time of trade;
a number of automated trading applications shown on the graph;
a composition of the portfolio of assets concerned;
a number of trading periods;
a percentage of the net open position that an automated trading application can trade;
a status of an automated trading application; and
a trading pattern to be applied by an automated trading application.

The method may further comprise an option to view an activity log for each automated trading application.

The method may further comprise an option for a user to intervene to place a trade on behalf of an automated trading application. For example, the user may select to carry out a manual trade based on the net open position of the automated trading application.

The method may further comprise refreshing the graph to reflect a change in a parameter in real-time. For example, a change may result from a trade and/or an update to the forecasted energy generation and/or the forecasted energy sales.

The trade may result in one of: an energy asset being turned on; an energy asset being turned up; an energy asset being turned off; or an energy asset being turned down. Thus, resulting in a change in the overall net open position of the automated trading application.

The forecasted energy generation may take into account one or more of: asset capacity; renewables generation forecast; asset generation forecast; market price for energy generated;
cost of generating energy.

The forecasted energy sales may take into account one or more of: time of day; time of week; time of year; renewables generation forecast.

The forecasted energy generation may be provided by one or more of: a battery; a wind turbine, a solar panel, a tidal generator or another energy source.

The method may further comprise one or more of: initiating a trade; completing a trade; and receiving confirmation of a trade once executed. Completing the trade may comprise placing an order on one or more exchange.

The method may further comprise updating the graph to reflect the trade once executed.

In accordance with a second aspect of the disclosure there is provided a non-transitory computer readable medium comprising instructions for carrying out the method as described above.

In accordance with a third aspect of the disclosure there is provided a computer system configured to carry out any aspects of the method described above.

These and other aspects will be apparent from the embodiments described in the following. The scope of the present disclosure is not intended to be limited by this summary nor to implementations that necessarily solve any or all of the disadvantages noted.

Any features described in relation to one aspect of the disclosure may be applied to any one or more other aspect of the disclosure.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Certain embodiments of the invention will now be described, by way of example only, with reference to the accompanying drawings, in which:

FIG. 1 shows a schematic representation of a trading system in accordance with an embodiment;

FIG. 2 shows a computer-implemented method for visualising a performance of at least one automated trading application in a short-term energy trading market in accordance with an embodiment;

FIG. 3 shows an example screenshot of a graph in accordance with an embodiment;

FIG. 4 shows an example screenshot of a graph in accordance with an embodiment;

FIG. 5 shows an enlarged portion of a graph showing automated trading application icons, in accordance with an embodiment;

FIGS. 6A to 6C show an enlarged portion of a graph showing changes to automated trading application icons to reflect status, in accordance with embodiments;

FIG. 7 shows an example screenshot of an activity log in accordance with an embodiment;

FIG. 8A shows a first example screenshot of a strategy screen for an automated trading application in accordance with an embodiment; and

FIG. 8B shows a second example screenshot of a strategy screen for an automated trading application in accordance with an embodiment.

### DETAILED DESCRIPTION OF CERTAIN EMBODIMENTS

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized, and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims and their equivalents. In the following embodiments, like components/steps are labelled with like reference numerals.

In the following embodiments, the term memory is intended to encompass any computer readable storage medium and/or device (or collection of data storage mediums and/or devices). Examples of memories include, but are not limited to, optical disks (e.g., CD-ROM, DVD-ROM, etc.), magnetic disks (e.g., hard disks, floppy disks, etc.), memory circuits (e.g., EEPROM, solid state drives, random-access memory (RAM), etc.), and the like.

As used herein, except wherein the context requires otherwise, the terms “comprises”, “includes”, “has” and grammatical variants of these terms, are not intended to be exhaustive. They are intended to allow for the possibility of further additives, components, integers or steps.

The functions or algorithms described herein are implemented in hardware, software or a combination of software and hardware in one or more embodiments. The software comprises computer executable instructions stored on computer readable carrier media such as a memory or other type of storage device. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, microcontroller or other type of processing device or combination thereof.

The methods of the present disclosure may use known statistical or trading strategy techniques to determine a net open position for a portfolio of assets being balanced in the current (prompt) trading market period. Accordingly, forecasting, for example, in relation to energy generation, energy sales and market price direction may be determined using any suitable techniques, a variety of which are readily available to persons skilled in the art. As such, this information is obtained from any suitable sources and then fed into the methods disclosed as input parameters. Consequently, details of specific forecasting techniques are not disclosed herein.

Similarly, although the methods described relate to visualising a performance of at least one automated trading application. The detailed operation of the automated trading applications themselves is not described herein. Such automated trading applications are known in the art and any automated trading application may be employed in conjunction with the methods described herein.

The methods may use inputs from a system of records that track a trader's or an organisation's commitments and forecasts to determine the net open positions (NOP) from which a trader can trade. One potential system of records is an Enterprise Data Management (EDM) tool, such as one developed by the applicant. The EDM tool may provide time series data used by the disclosed methods to calculate the NOP from which to trade. The time series data may include asset specific information on a per time period basis covering, for example, Maximum Generation, Minimum Generation, Production Plan, also known as Physical Notification (PN), reserve and ancillary commitments. This data may be configured to flow from the EDM to a system operating any of the disclosed methods any time it is changed or updated, within a few seconds, to ensure the trader (or automated trading application) is provided with the most up to date view of their position.

Once the position is determined then a new bespoke way of viewing the data is employed to create a novel user experience, which may simultaneously present the performance of multiple automated trading applications in a live tradable visualisation.

Specific embodiments will now be described with reference to the drawings.

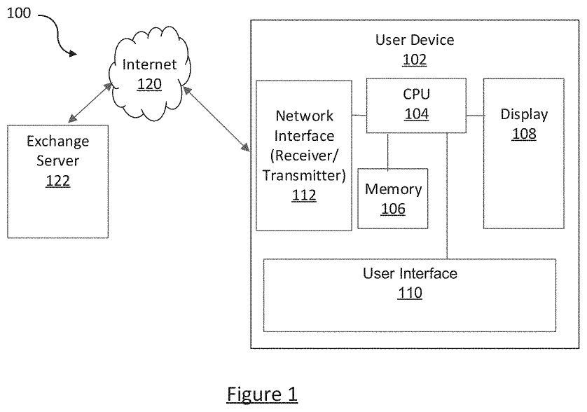

FIG. 1 illustrates a trading system 100 according to the disclosure. The system 100 comprises a user device 102, which may take the form of a personal computer (PC), laptop, tablet or the like. The user device 102 comprises a processor in the form of a central processing unit (CPU) 104, which is connected to a memory 106, a display 108, a user interface 110 and a network interface (receiver/transceiver) 112. The network interface 112 is configured to connect the user device (via a wired or wireless connection) to the internet 120. An exchange server 122 is also connected to the internet 120 and data and/or instructions may be transmitted in both directions between the user device 102 and the exchange server 122, via the internet 120.

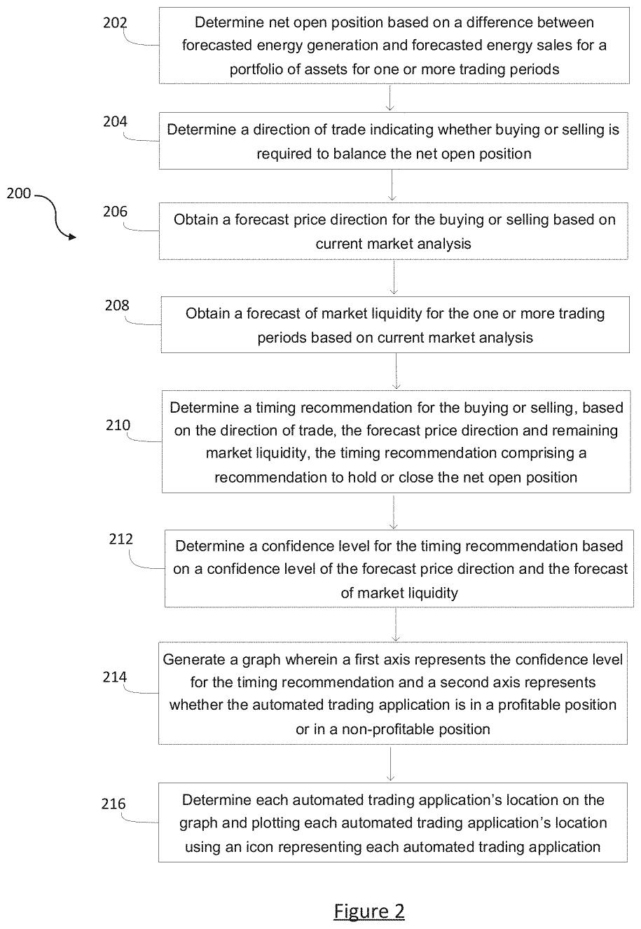

The memory 106 may comprise a non-transitory computer readable medium comprising instructions for carrying out the method of FIG. 2 as described below.

The display 108 may comprise a liquid crystal display, a light-emitting diode display or another display device.

In some embodiments, the user interface 110 may take the form of a touch screen and, in which, case, the user interface 110 may be integrated into the display 108. In other embodiments, the user interface 110 may comprise one or more of: a keyboard, a mouse, a tracker or a speech recognition device.

The network interface 112 may comprise a modem or cellular interface for connecting the user device 102 to the internet 120.

The exchange server 122 may comprise one or more processors and one or more memories for hosting the exchange. In practice, a plurality of user devices 102 will be connected to the exchange server 122 via the internet 120 to allow a plurality of users to trade on the exchange.

In some embodiments, one or more functions of the user device 102 may be carried out remotely. For example, one or more of the operations carried out by the CPU 104 and/or memory 106 may be performed via a cloud-based service, connected to the user device 102 via the network interface 112 and internet 120.

FIG. 2 shows a computer-implemented method 200 for visualising a performance of at least one automated trading application in a short-term energy trading market. The method comprises a step 202 of determining a net open position based on a difference between forecasted energy generation and forecasted energy sales for a portfolio of assets for one or more trading periods. A step 204 comprises determining a direction of trade indicating whether buying or selling is required to balance the net open position. A step 206 comprises obtaining a forecast price direction for the buying or selling based on current market analysis and a step 208 comprises obtaining a forecast of market liquidity for the one or more trading periods based on current market analysis. A step 210 comprises determining a timing recommendation for the buying or selling, based on the direction of trade, the forecast price direction and remaining market liquidity, the timing recommendation comprising a recommendation to hold or close the net open position. A step 212 comprises determining a confidence level for the timing recommendation based on a confidence level of the forecast price direction and a confidence level of the forecast of market liquidity. A step 214 comprises generating a graph wherein a first axis represents the confidence level for the timing recommendation and a second axis represents whether the automated trading application is in a profitable position or in a non-profitable position. A step 216 comprises determining each automated trading application's location on the graph and plotting each automated trading application's location using an icon representing each automated trading application.

Accordingly, the method 200 allows the user determine at a glance whether the automated trading application is in a profitable position or in a non-profitable position alongside a confidence level associated with waiting to trade. A user can therefore quickly assess the performance of each automated trading application and can decide to intervene if necessary.

The net open position may be calculated using time series data (e.g. a production plan) and market data (e.g. private trades for half hour products) obtained from external trading sources.

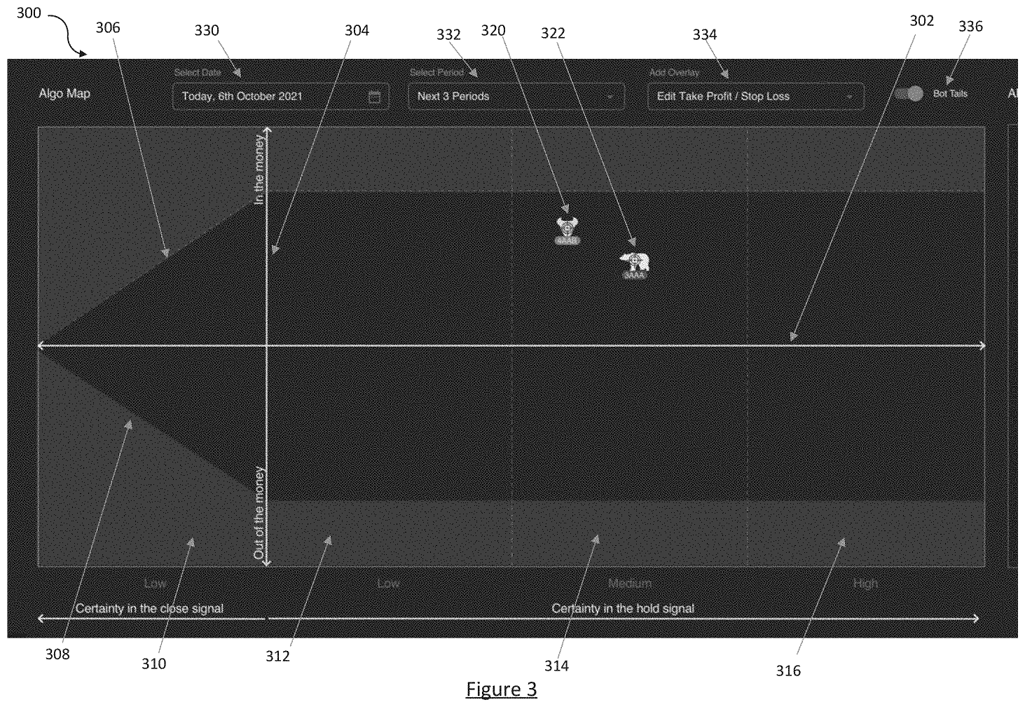

An example, of operation of the method 200 is described in more detail with respect to FIG. 3.

FIG. 3 shows an example screenshot of a graph 300 in accordance with an embodiment. As shown, the graph 300 comprises a first horizontal x-axis 302 denoting confidence level for the timing recommendation (i.e. confidence in certainty for holding or closing a net open position) and a second vertical y-axis 304 denoting whether the automated trading application is in a profitable position (“in the money”) or in a non-profitable (“out of the money”) position. Absolute results will be normalised to allow automated trading applications with different prices to be plotted on the same scale.

A positive side of the y-axis 304 indicates a profitable position and a negative side of the y-axis 304 indicates a non-profitable position. Whether the automated trading application is in a profitable position or in a non-profitable position may be determined by subtracting a first market price from when the automated trading application started trading from a current market price. In which case, a positive result is “in the money” for a sale and “out of the money” for a buy and a negative number is “out of the money” for a sale and “in the money” for a buy. For example, if a trader has chosen not to sell when the market price was £100 and the market price then rises to £150, the trader will be £50 “in the money”. Conversely, if a trader has chosen not to sell when the market price was £100 and the market price then falls to £50, the trader will be £50 “out of the money”.

On the y-axis 304, an upper limit 306 is shown by a green line (setting an upper limit for closing the net open position to take profit) and a lower limit 308 is shown by a red line (setting a lower limit for closing the net open position to stop losses). Thus, configuration of the upper limit 306 and lower limit 308 allows a user to set boundaries to dictate an optimal timing for closing a position to maximise profit and minimise loss.

On a positive side of the x-axis 302 there is a first zone 312 indicating a low confidence level for holding the net open position; a second zone 314 indicating a medium confidence level for holding the net open position; and a third zone 316 indicating a high confidence level for holding the net open position. For example, the low confidence level may be less than 30%, the medium confidence level may be from 30% to 70%; and the high confidence level may be greater than 70%.

On a negative side of the x-axis 302 there is a fourth zone 310 indicating a low confidence level for closing the net open position. For example, the low confidence level may be less than 30%.

The positive side of the x-axis 302 therefore conveys the certainty level in the hold signal (i.e. the timing recommendation to wait) and the negative side of the x-axis 302 conveys the certainty in the close signal (i.e. the timing recommendation to close now). Low, medium and high confidence levels can be associated with the hold signal, whereas only a low confidence level is associated with the close signal because it makes sense to close a net open position (i.e. execute a trade) irrespective of the certainty level to close.

The option to hold the position or to close the position is considered the timing recommendation.

The step of determining the timing recommendation comprises determining to close the net open position when either: the direction of trade is to buy and the forecast price direction is rising; or the direction of trade is to sell and the forecast price direction is falling; and determining to hold the net open position when either: the direction of trade is to buy and the forecast price direction is falling; or the direction of trade is to sell and the forecast price direction is rising.

The confidence level for the timing recommendation is determined by the confidence level of the forecast price direction and a confidence level that sufficient market liquidity remains to allow the net open position to be closed. For example, if historical analysis of the price direction showed a strong correlation to the instrument being traded combined with an expected large price movement this would indicate a high price movement confidence. This would then be combined with the forecast of market liquidity to determine how long the position should be held open. For example, a highly confident automated trading application could wait until the 85^{th} percentile of predicted market liquidity before closure whereas a medium confidence position might be closed earlier, reducing risk, at the 60^{th} percentile of predicted market liquidity.

A first automated trading application 320 and a second automated trading application 322 are plotted on the graph 300. In this example, the first automated trading application 320 is slightly more “in the money” than the second automated trading application 322 and both are within the second zone 314 indicating a medium confidence level for holding the net open position.

The position of the automated trading applications 320, 322 within the graph 300 will be scaled via data normalisation using a standardised approach so that each automated trading application 320, 322 will be positioned correctly within the graph 300 relative to: the confidence levels, the take profit and stop loss limits and the y-axis 304 conveying whether the automated trading application is in a profitable position or in a non-profitable position.

The graph 300 allows a user to track how the automated trading applications 320, 322 are performing based on movement and position of the automated trading applications 320, 322 within the graph 200.

The graph 300 may be configurable by user interface filters that enable the selection of a date 330, a number of future trading periods 332, an option to select a trading pattern applied 334 (i.e. to edit to upper and lower limits 306, 308) and an option to track “Bot Tails” 336 (i.e. to view a path that an automated trading application has taken).

The date 330, corresponding to the date of the data displayed in the graph 300, may be defaulted to the present day, with an option to manually select today or tomorrow using a drop-down menu.

The selection of the number of future trading periods 332 may be for one or more future consecutive trading periods. In the present example, the trading periods may each be half hour trading periods and a maximum number of ten periods may be selected. In other examples, the trading period duration may be different and/or the maximum number of periods that can be selected may be different.

The number of trading periods selected may reflect the number of automated trading applications displayed in the graph 300, where each automated trading application is configured for a respective one of the trading periods.

The present example is suitable for the market of Great Britain, which has half-hourly trading (or settlement) periods, hence 48 periods in one day. However, in other markets the trading periods may be different. For example, in the Nordic market, settlements are currently executed at an hourly level (hence 24 periods in a day), but will shift to every 15-minutes in 2023 (hence 96 periods in a day).

It will be understood that the present method enables the configuration of the graph 300 for automated trading applications to operate within. The configuration of the automated trading applications themselves, to complement trading strategies, will also be described. In addition, the actions of the automated trading applications can be tracked and the status of each automated trading application may be visually represented in smart visualisations as will be described below.

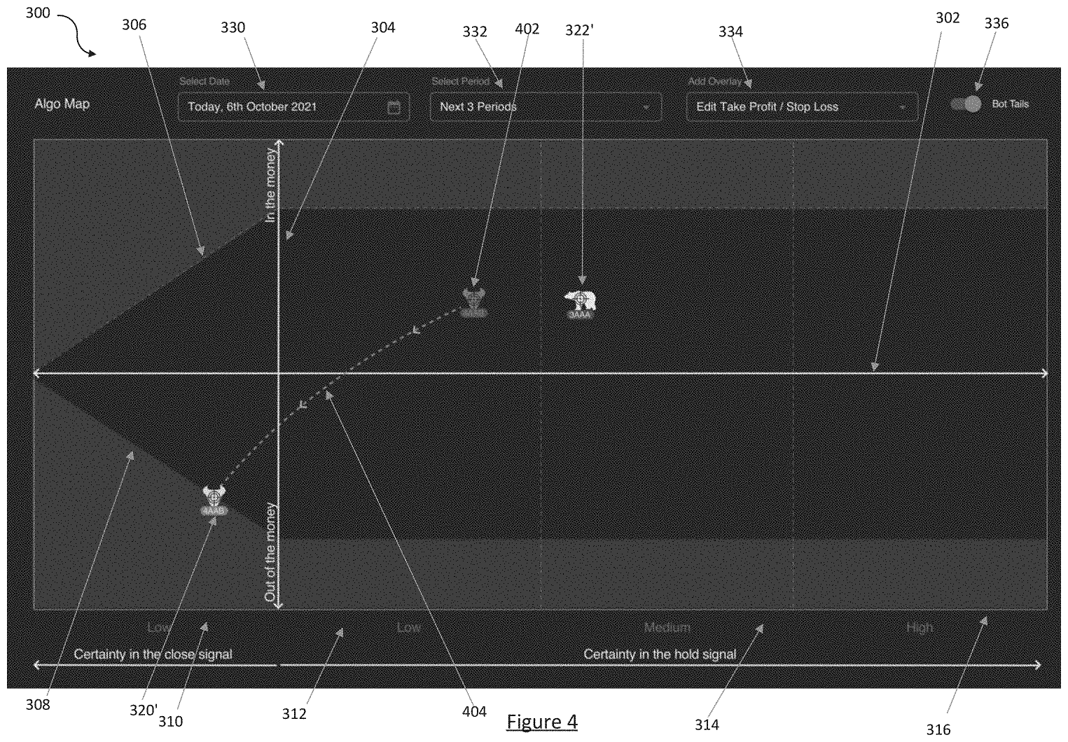

FIG. 4 shows an example screenshot of the graph 300 in which the option to track “Bot Tails” 336 has been toggled to on and the positions of the automated trading applications 320′ and 322′ are different from those in FIG. 3. In addition, a previous position (i.e. location) of the automated trading application 320′ is shown by a feint icon 402 at the previous position on the graph 300. A path 404 indicating a path of movement of the automated trading application 320′ from the previous position 402 to the current position 320′ is shown and one or more arrows are provided on the path 404 to indicate a direction of movement of the position of the automated trading application along the path 404. As such, past movement of the automated trading application 320′ can be tracked on the graph 300 to indicate if the automated trading application 320′ is improving its position. The path 404 may be considered to be a “Tail” in a similar manner to a comet tail which indicates the direction a comet is travelling in.

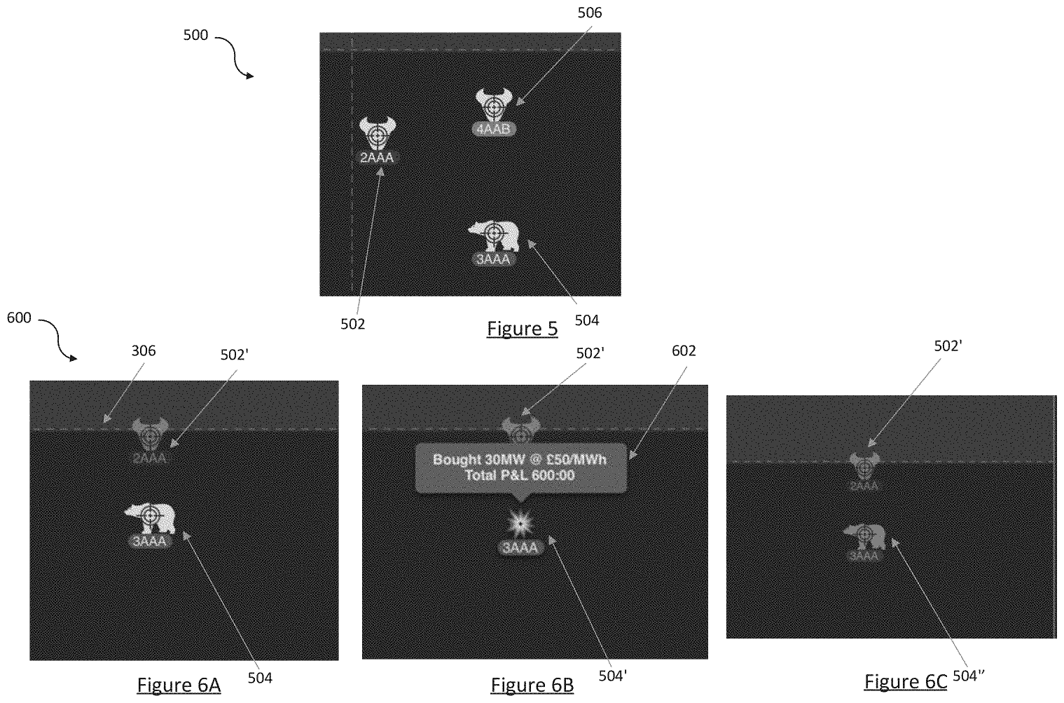

FIG. 5 shows an enlarged portion of a graph 500 showing three automated trading application icons, in accordance with an embodiment. Each icon may be configured to provide a visual representation of a trading pattern being applied by the associated automated trading application. For example, the icon may be a bull in the case of a rising market where the aim is to sell at a high price and a bear in the case of a falling market where the aim is to buy at a low price. Other animals or other visual representations may be used. The icon may also include an identifier (ID) for the automated trading application concerned. In some cases, the identifier may indicate the trading period associated with the automated trading application.

As shown in FIG. 5, a first automated trading application icon 502 is in the shape of a bull's head with a target cross overlay to denote the precise position of the automated trading application on the graph 500. The first automated trading application icon 502 has an identifier 2AAA, where the 2 represents period 2 and AAA represents the automated trading application.

A second automated trading application icon 504 is in the shape of a bear with a target cross overlay to denote the precise position of the automated trading application on the graph 500. The second automated trading application icon 504 has an identifier 3AAA, where the 3 represents period 3 and AAA represents the automated trading application.

A third automated trading application icon 506 is in the shape of a bull's head with a target cross overlay to denote the precise position of the automated trading application on the graph 500. The third automated trading application icon 506 has an identifier 4AAB, where the 4 represents period 4 and AAB represents the automated trading application.

The icons may be configured to indicate a status of the automated trading application as will be described below.

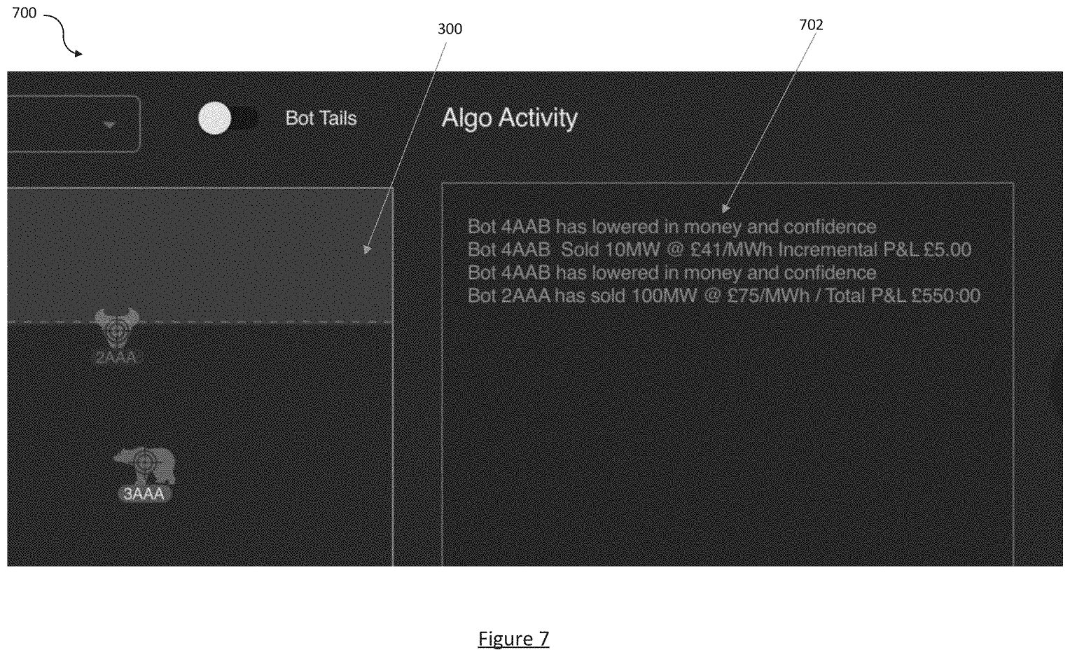

FIGS. 6A to 6C show an enlarged portion of a graph 600 showing changes to automated trading application icons to reflect status, in accordance with the disclosure. The status of the automated trading application may be one of: active; paused; or in-active (killed). The active state may refer to a ‘normal’ state in which an automated trading application may automatically execute trades. When paused, the automated trading application will not automatically execute until it is switched back to the active state. When killed, the automated trading application will be terminated and cannot be set back to an active state.

The method 200 may comprise showing a visible change to an icon on the graph when an action occurs. For example, the icon may fade (or be greyed out) when the net open position is balanced, a trading period is closed or the automated trading application is paused. Furthermore, the icon may explode when an action occurs, for example, the icon may explode when a trade is executed to bring the net open position to zero (i.e. when the role of the automated trading application has been fully executed).

Thus, the activity status of the automated trading application can be tracked by the visual nature of the icons on the graph. In some cases, animations may be used to show visual changes to the icons.

FIG. 6A shows the icon 504 in a ‘normal’ active state. However, the icon 502′ is shown in a faded state compared to the icon 504. This indicates that the icon 502′ is in-active (killed) or paused. For example, the icon 502′ may have been killed when it reached the upper limit 306 (i.e. the automated trading application associated with the icon 502′ may have executed an order to close its position to take profit when it reached the upper limit 306).

FIG. 6B shows the icon 504′ changed from the bear to an explosion to indicate that the associated automated trading application has fully balanced its net open position. As shown in FIG. 6C, the explosion may be replaced by a grey out icon 504″ after execution. A similar change (to an explosion before fading out) may be indicated when the period associated with the automated trading application has reached gate closure (i.e. when trading for the period is no longer possible).

As shown in FIG. 6B, a hovering a mouse pointer over the icon 504′ displays a tooltip 602 providing details of the action. In this case, the tooltip 602 confirms that 30 MW was bought at £50/MWh, leading to a total profit or loss of +£600.

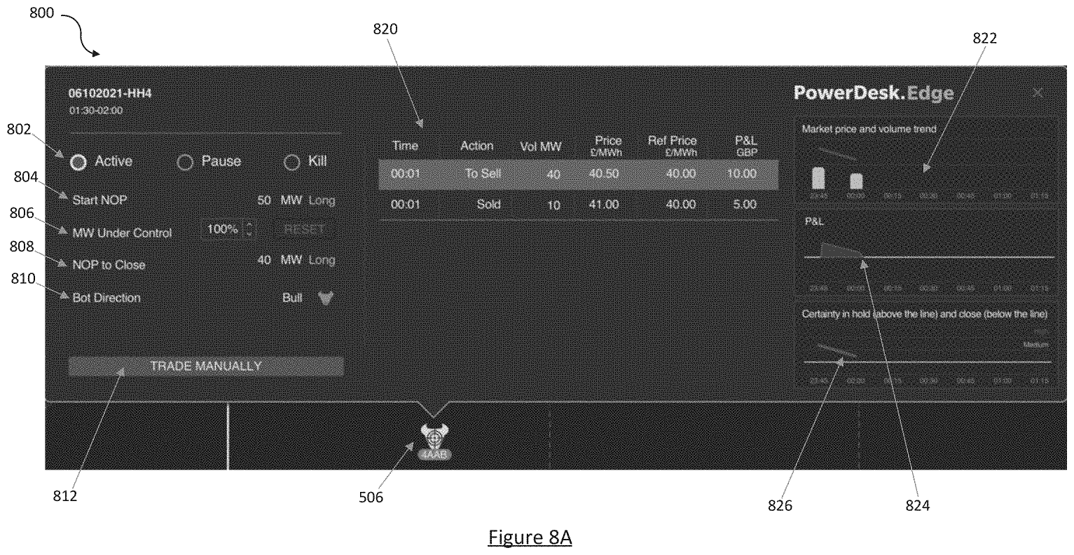

FIG. 7 shows an example screenshot 700 of an activity log 702 in accordance with the disclosure. In this case, the activity log 702 is shown in a box to the right of the graph 300 although in other cases, the activity log 702 may be shown in a different part of the screen or in a separate (e.g. pop-up) screen. The activity log 702 may record details of all changes and activity associate with each automated trading application. For example, the activity log 702 may list details of trades, total or incremental changes to profit or loss, changes in confidence levels and changes in money (e.g. the amount “in the money” or “out of the money”). The activity may be listed by the time of the action with the most recent action being shown at the top of the list. In some cases, separate activity logs 702 may be shown for each automated trading application.

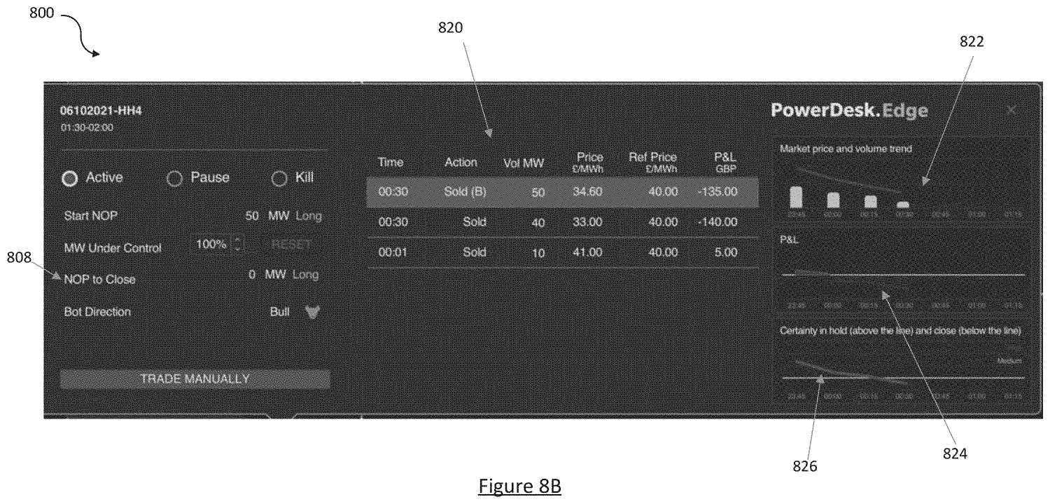

FIG. 8A shows a first example screenshot of a strategy screen 800 for an automated trading application in accordance with the disclosure. A user may configure each automated trading application by clicking on the respective icon (e.g. icon 506) on the graph 300. This will launch the strategy screen 800 in a pop-up window.

The strategy screen 800 enables the user to set the status 802 of the automated trading application to ‘Active’, ‘Pause’ or ‘Kill’. The start net open position (NOP) 804, which the automated trading application should aim to close, is shown (in this case, the NOP is 50 MW long). The start NOP 804 is shown in MW along with an indication of whether the position is ‘long’ or ‘short’. Where long the automated trading application should sell to balance NOP, and when short the automated trading application should buy to balance NOP.

The strategy screen 800 allows the user to set a percentage of NOP that an active automated trading application can automatically trade. This is denoted as MW under control 806 (i.e. under control of the automated trading application). The default for this may be 100% although the user may optionally change this to a different value using a drop down filter and may subsequently reset the percentage back to the default value. The current NOP to close 808 is also listed (in this case, the NOP to close is 40 MW long as 10 MW have already been sold). In addition, the ‘Bot Direction’ 810 is indicated (i.e. the trading direction of the automated trading application). The direction may be represented by a ‘Bull’ or a ‘Bear’ suggesting a sell in a Bull market and a buy in a Bear market, which is consistent with the animal visualisation of the automated trading application on the graph 300.

The strategy screen 800 also includes a table 820 listing proposed and past trading actions with the related time, quantity, prices (i.e. market price and reference price, denoting an internal benchmark price) and associated profit/loss. For example, at 00:01 it is proposed that the automated trading application sells 40 MW as the NOP to close 808 is 40 MW Long, because 10 MW has just been sold to partially fill the start NOP 804 of 50 MW. A profit of £5 was made from the sale, which is derived from the following calculation with £1/MWh being the difference between the market price and the reference price.

10 MW*£1/MWh/2=£5

As shown in FIG. 8B, if the market price changes to £33/MWh subsequently (i.e. at time 00:30), and 40 MW is sold to fully close out the start NOP 804 (i.e. to bring the NOP to close 808 to 0 MW), then a loss of £140 would be incurred based on a price difference of £7 (i.e. 40 MW*£7/MWh/2). The overall net profit/loss would be a £135 loss and a Volume Weighted Average Price (VWAP) may be displayed for the total executed order (e.g. £34.60).

Trading actions may be denoted in the table 820 either by a letter ‘B’ denoting an action by the automated trading application or by a letter ‘T’ denoting a manual trader action.

The strategy screen 800 may also enable a user to easily compare the trading actions in the table 820 against various data as shown in graphs 822, 824 and 826. Graph 822 shows market price and volume trend, graph 824 shows profit and loss (P&L) for the automated trading application and graph 826 shows certainty in holding or closing a position, with each graph depicted over the same time periods. In the graph 824, profit is shown in green above a horizontal line and loss is shown in red below the horizontal line. In the graph 826, the certainty in holding the position is shown above a horizontal axis and the certainty in closing the position is shown below the horizontal axis. As per the graph 300, the certainty in closing the position is only ever low, however, the certainty in holding the position can be categorised as low, medium or high depending on the certainty in the timing recommendation as derived from the certainty in the market price direction.

Each of the graphs 822, 824 and 826 share the same 15 minute increment time intervals in the display of the data, although the data inputs for these graphs could be of a lower (or higher) granularity.

The user can use the graphs 822, 824 and 826 to cross-check the past actions in the table 820.

The strategy screen 800 also has a button 812 to allow the user to ‘Trade Manually’ to intervene in the operation of the automated trading application. Selecting the button 812 may open a trading screen or trading application to allow the user to manually execute a trade for a desired quantity or price. As such, the method and system described herein supports a hybrid optimised approach to trading.

In general, short term energy trading decisions rely on market prices and the prediction of these price movements. The present disclosure enables traders to trade more effectively as trading strategies for different time periods can be traded automatically and concurrently with the performance of each automated trading application easily being monitored by the trader/user. Furthermore, traders can opt to manually intervene as deemed relevant in order to maximise profits and minimise losses or reduce risk.

The described systems and methods enable traders to trade more intelligently and efficiently as they can visualise the performance of multiple (e.g. up to 10) automated trading applications simultaneously. Thus, providing a greater opportunity for the trader to intervene at an appropriate time in the event that an automated trading application is not performing as expected. Notably, the user may have the chance to intervene on any one or more of the many automated trading applications being monitored.

The automated trading applications may therefore replace and/or supplement manual trading as relevant to achieve optimal timing for the close out of positions in order to maximise profit and minimise loss or risk in a fast-changing market.

The present system and method provide a unique user interface and user experience including an intuitive and visual representation of the automated trading applications and their associated confidence levels and trading pattern (i.e. boundaries for taking profit/minimising loss) that they operate within. The direction of movement within these confidence levels, and the related trails tracking this movement can quickly and easily be viewed for multiple automated trading applications on the same screen.

This approach is pertinent to any trading activity for contiguous short term trading instruments, such as energy, gas, transmission, and other products in the financial sector.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Furthermore, features described in relation to one embodiment may be mixed and matched with features from one or more other embodiments, within the scope of the claims.

1. A computer-implemented method for visualising a performance of at least one automated trading application in a short-term energy trading market, the method comprising:
determining a net open position based on a difference between forecasted energy generation and forecasted energy sales for a portfolio of assets for one or more trading periods;
determining a direction of trade indicating whether buying or selling is required to balance the net open position;
obtaining a forecast price direction for the buying or selling based on current market analysis;
obtaining a forecast of market liquidity for the one or more trading periods based on current market analysis;
determining a timing recommendation for the buying or selling, based on the direction of trade, the forecast price direction and remaining market liquidity, the timing recommendation comprising a recommendation to hold or close the net open position;
determining a confidence level for the timing recommendation based on a confidence level of the forecast price direction and the forecast market liquidity;
generating a graph wherein a first axis represents the confidence level for the timing recommendation and a second axis represents whether the automated trading application is in a profitable position or in a non-profitable position;
determining each automated trading application's location on the graph and plotting each automated trading application's location using an icon representing each automated trading application.

2. The method of claim 1 wherein the at least one automated trading application comprises a trained machine-learning algorithm.

3. The method of claim 1 further comprising:
determining for each automated trading application:
an upper boundary for closing the net open position to take profit; and
a lower boundary for closing the net open position to stop losses; and
indicating the upper boundary and the lower boundary on the graph.

4. The method according to claim 3 further comprising normalising each automated trading application's position along the second axis such that each automated trading application can be viewed relative to a common upper boundary and a common lower boundary.

5. The method according to claim 1 wherein the first axis comprises a first zone indicating a low confidence level for holding the net open position; a second zone indicating a medium confidence level for holding the net open position; a third zone indicating a high confidence level for holding the net open position.

6. The method according to claim 1 wherein the first axis comprises a fourth zone indicating a low confidence level for closing the net open position.

7. The method according to claims 5 and 6, wherein the fourth zone is indicated on a first side of the second axis and the first zone, the second zone and the third zone are indicated on a second side of the second axis.

8. The method according to claim 1 wherein a first side of the first axis indicates a profitable position and a second side of the first axis indicates a non-profitable position.

9. The method according to claim 1 wherein the first axis is a vertical y-axis and the second axis is a horizontal x-axis.

10. The method according to claim 1 wherein the confidence level for the timing recommendation is determined by the confidence level of the forecast price direction and a confidence level that sufficient market liquidity remains to allow the net open position to be closed.

11. The method according to claim 1 wherein whether the automated trading application is in a profitable position or in a non-profitable position is determined by subtracting a first market price from when the automated trading application started trading from a current market price.

12. The method according to claim 1 further comprising an option to display one or more of: a previous location for at least one automated trading application; a path of movement of the location for at least one automated trading application; and a direction of movement of the location of the at least one automated trading application along the path.

13. The method according to claim 1 wherein determining the timing recommendation comprises:
determining to close the net open position when either:
the direction of trade is to buy and the forecast price direction is rising; or
the direction of trade is to sell and the forecast price direction is falling; and
determining to hold the net open position when either:
the direction of trade is to buy and the forecast price direction is falling; or
the direction of trade is to sell and the forecast price direction is rising; and, optionally, comprising
in response to a determination to hold the net open position, considering the forecast of market liquidity to determine how long the position should be held open for; and
determining to close the net open position when the remaining market liquidity reaches a predetermined threshold.

14. The method according to claim 1 wherein the icon is configured to provide a visual representation of a trading pattern being applied by the automated trading application; optionally, wherein the icon is a bull in the case of a rising market and a bear in the case of a falling market.

15. The method according to claim 1 wherein the icon is configured to indicate a status of the automated trading application; optionally, wherein the status of the automated trading application is one of: active; paused; or in-active.

16. The method according to claim 1 further comprising showing a visible change to an icon on the graph when an action occurs; optionally, wherein the visible change comprises one or more of:
an explosion when a trade is executed; and
a fading out when the net open position is balanced or a trading period is closed.

17. The method according to claim 1 further comprising an option for a user to configure one or more of:
a date or time of trade;
a number of automated trading applications shown on the graph;
a composition of the portfolio of assets concerned;
a number of trading periods;
a percentage of the net open position that an automated trading application can trade;
a status of an automated trading application; and
a trading pattern to be applied by an automated trading application.

18. The method according to claim 1 further comprising an option to view an activity log for each automated trading application.

19. The method according to claim 1 further comprising an option for a user to intervene to place a trade on behalf of an automated trading application.

20. A non-transitory computer readable medium comprising instructions for carrying out the method according to claim 1.
